(19) United States
(12) Patent Application Publication
(10) Pub. No.: US 2013/0298847 A1
(43) Pub. Date: Nov. 14, 2013

(54) ANIMAL HANDLING AND TRAINING AID

(71) Applicant: Michael J. McAllister, Malvern, PA (US)

(72) Inventor: Michael J. McAllister, Malvern, PA (US)

(21) Appl. No.: 13/889,642

(22) Filed: May 8, 2013

Related U.S. Application Data
(60) Provisional application No. 61/644,919, filed on May 9, 2012.

(51) Int. Cl. A01K 27/00

(52) U.S. Cl. CPC A01K 27/003
USPC 119/799

(57) ABSTRACT

An animal handling and training aid including a leash control bar having first and second members and a fastener device arranged in one of the control bar members for connecting the first and second members in an end-to-end configuration through an animal restraint device.

This application claims the benefit of provisional application No. 61/644,919 filed May 9, 2012.

### BACKGROUND OF THE INVENTION

The invention herein generally relates to a device that is used in conjunction with a length of strapping material, cord or chain to form a novel combination which results in an improved restraint or leash for animal handling and training. The leash includes a sturdy, short bar positioned perpendicular to the length of the cord or chain and the leash bar, when grasped by the handler or trainer, provides a significant increase in one's ability to control an untrained or pulling animal, such as a dog.

The invention affords the handler or trainer the capability to substantially strengthen his or her control over an unruly dog while training the dog to position itself on the handler or trainer's left side. As most people are right-handed, estimated to be as much as 90% of the U.S. population, the left side is the non-dominant side for most handlers and trainers. The left side tradition is actually also a requirement of the “Obedience Regulations, Amended to Jul. 1, 2013” of The American Kennel Club [AKC], of New York, N.Y. The organization, founded in 1884, widely disseminates its Obedience Regulations which state, in part, “The Obedience Regulations set the standard of perfection by which the performance of each dog is scored and give the judge little choice in deciding how an exercise is to be performed.” “Heel Position,” in Chapter 2, Section 18 of the Regulations states, “The dog should be at the handler's left hip.”

This requirement permits the free hand to connect a leash or cleanup after a dog. In the case of a police officer, the unobstructed access to a holstered weapon is paramount. A right-handed police officer's weapon would be worn on his or her right side and so, a police dog is properly situated on the officer's left.

The AKC underscores its conviction that the Heel Position be on the handler's left side in Chapter 4 of its Regulations, wherein it advises for physically challenged handlers, “It is proper for a judge to establish in advance a position on the disabled handler's left side that corresponds to the normal heel position for all exercises.”

Although much has been said of the conventional heel position being on the left, many left-handed dog handlers and trainers prefer to have their animal located to their right. It is important to note, however, that in either case there is a strong natural preference for having the dog on the non-dominant side, controlled by the hand on that side, leaving the dominant hand free for other purposes. The present invention provides the handler or trainer greatly improved control no matter on which side he or she locates the dog.

Recognizing a requirement that proper dog training teaches a dog to heel on one's left side supports the important utility of the present invention. Training a dog to heel can be especially difficult because the left side is the non-dominant or weaker side for most dog handler or trainers' hands. Even dogs that heel well can suddenly and unexpectedly pull with great strength, for instance, to meet another dog or greet a person. This pulling can jerk a traditional leash through the hand of the handler or trainer, causing friction that can damage the skin and the repetition of this action can result in the painful sprain of the hand and wrist.

If the dog is able to surprise the handler or trainer, it can break free from the handler or trainer's control which may cause a host of other serious problems. The invention provides the handler or trainer a leash control bar to hold and to rely upon in a situation where a strong dog can wrest control from a handler or trainer. The leash control bar also evokes a natural grasp by which control of a dog, especially, on a trainer or handler's weaker left side, can be maintained. The control bar simply improves the ability to significantly restrain and manage an animal.

The invention takes full advantage of a human's innate and strong prehensility or ability to grasp. This prehensile capability is found in the hands of primates and is especially present due to the presence of an opposable thumb. The opposability of even a partially rotating thumb forcefully pressing against the fingers provides a strong secure grip that supports a firm grasp of a limb, bat, club or pole. A trainer or handler's closed fist made with the palm of the hand and fingers, including opposable thumb, around a generally cylindrical form within it, such as the leash control bar of the invention herein, becomes a defiant antidote to the often dangerous pulling action of a strong animal. The ready capability to clutch, grab and firmly hold the leash control bar of the invention is one of the more significant benefits it provides. Using the invention, the handler or trainer's ability to maintain control authority over a strongly pulling animal is greatly supported and enhanced.

### SUMMARY OF THE INVENTION

Accordingly, the invention herein is directed to a combination of a length of strapping material, cord or chain and a short, sturdy leash control bar situated on and perpendicular to the leash, which provides an animal handler or trainer with a novel capability to control and, if necessary, restrain a strong animal. Many breeds of dog were once used to pull carts, much as a horse pulls a wagon. Using a leash to handle these breeds is especially difficult because the sudden and unexpected strong pulling action can easily catch the handler or trainer off-guard. Additionally, an attempt to clamp down on a conventional leash as it rapidly rips through a relatively tight grip is often unsuccessful and damaging to the hand.

The leash control bar of the invention herein provides a convenient and natural grip on a leash that, when grasped, immediately signals to the pulling animal that the handler or trainer is retaining authority. Simultaneously, the leash control bar creates the means by which the handler or trainer can instantly exert a countervailing force, in the opposite direction of the animal's pull, to regain control over and management of the animal. The coordination of a signal to the dog combined with automatic and immediate resistance to the dog's unruly behavior is the handler or trainer's first step in training a dog to heel.

In addition, the invention herein employs a natural mechanism that instantly and automatically sends a signal of resistance to a pulling dog. Ordinarily, when a dog challenges a handler or trainer by suddenly pulling away, the dog's sense of momentary freedom is its immediate reward. Thereby, the dog is encouraged to pull again and again. An alert handler or trainer would immediately begin to attempt to regain control, often resulting in a tug-of-war between the dog and the handler or trainer who must work against the reward of momentary freedom. The invention herein provides the handler or trainer with a valuable tool that discourages pulling.

With the leash control bar of the invention herein, a dog instantly and automatically receives a continuing signal of resistance to each of its steps in a pulling direction. These signals come from the total weight of the handler or trainer's hand, wrist and entire arm that are all connected by even a relaxed prehensile hand on the leash control bar of the invention. Rather than gaining inches of freedom in the pulling direction, due to a sliding leash jerked through a handler's or trainer's hand, the dog feels instant resistance. The handler does not have to try to grab hold of a sliding, burning, leash. He or she needs only clamp down on the grip they already have to re-exert authority over the unruly dog. This grip is entirely provided and accommodated by use of the leash control bar of the invention herein.

### BRIEF DESCRIPTION OF THE FIGURES

Other objects and advantages of the present disclosure will become apparent from a study of the following specification, when viewed in the light of the accompanying drawings, in which:

FIGS. 1, 2, and 3 are exploded, partially assembled and fully assembled views, respectively, of the leash control bar according to the invention;

FIG. 4 is a side view of one of the members of the control bar;

FIG. 5 is a side view of the leash control bar mounted on the leash; and

FIG. 6 is a partial perspective view of the leash control bar and leash as it is grasped by a human hand.

### DETAILED DESCRIPTION

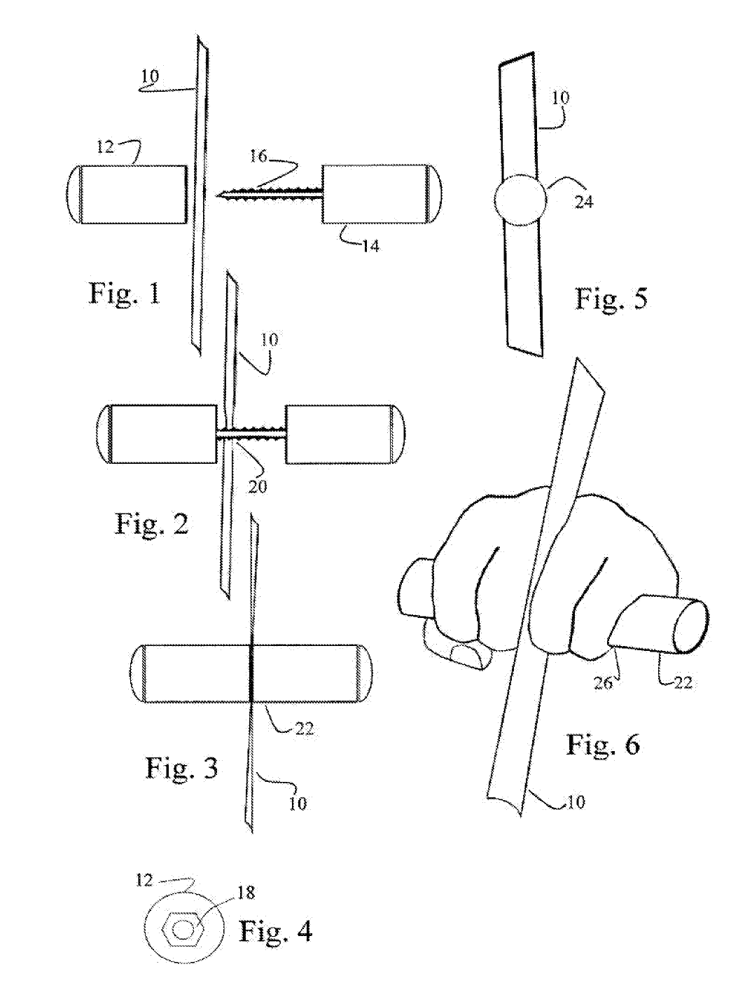

Referring to the drawings, the invention is shown in FIG. 1 in a disassembled condition. Strapping material, cord or chain 10 is arranged perpendicular to two members 12, 14 of a leash control bar. The strapping material can be any suitable material including leather or woven fabric typically used in a leash. The preferred embodiment of the leash control bar 12, 14, when fully assembled and attached to the leash 10, preferably measures no more than fourteen inches in length and four inches in diameter. In a preferred embodiment of the invention a penetrating screw 16 is depicted in the first member 14 of the leash control bar, while a threaded opening, not illustrated, is arranged in the second member 12 of the leash control bar and together the penetrating screw and threaded opening serve to join the two members of the leash control bar and firmly attach the leash between the two members of the bar. In an alternative embodiment of FIG. 4, the threaded opening includes a nut 18 embedded in the second member 12 of the leash control bar for receiving the screw of first member 14 of the leash control bar.

FIG. 2 shows the penetration of the leash 10, where the screw 16 pierces it 20 to create an opening at the attachment point.

FIG. 3 shows the fully penetrated leash 10 and the joined bar 12, 14, to form the leash control bar 22. A side plan view of the leash 10 is shown in FIG. 5. As shown in the drawings, the free ends 24 of the bar members are preferably rounded.

FIG. 6 shows the natural aforementioned prehensile human grip 26 around the cylindrical leash control bar 22 affording a natural grip for the handler or trainer, which provides them stronger and safer control over the leash 10 and therefore of the animal connected thereto. This design prevents damage to the hand, fingers or both of anyone attempting to control the sudden lunge of a strong, unruly animal that may otherwise occur while using only a traditional leash strap.

The foregoing is given by way of illustration, and not limitation. Variations on these will occur to those skilled in the art, and are not meant to be excluded from the scope of the claims that follow.

What is claimed is:

1. An animal handling and training aid comprising
(a) a control bar having first and second members;
(b) a fastener device arranged in at least one of said control bar first and second members for connecting said first and second members in an end-to-end configuration; and
(c) an animal restraint device arranged between said first and second members.

2. An animal handling and training aid as defined in claim 1, wherein said first and second members have a longitudinal configuration and are arranged coaxially when connected.

3. An animal handling and training aid as defined in claim 1, wherein said animal restraint device is arranged perpendicular to the axis of said control bar.

4. An animal handling and training aid as defined in claim 1, wherein said fastener device includes
(a) a screw projecting from one end of said first member of said control bar; and
(b) a threaded opening arranged in one end of said second member of said control bar whereby said screw engages said threaded opening to removably connect said control bar first and second members.

5. An animal handling and training aid as defined in claim 4, wherein said threaded opening comprises a nut arranged in one end of said second member of said control bar.

6. An animal handling and training aid as defined in claim 1, wherein said control bar is generally cylindrical.

7. An animal handling and training aid comprising:
(a) a control bar having first and second members; and
(b) a fastener device arranged in one of said control members for connecting said first and second members in an end-to-end configuration through an animal restraint device.
